(19) United States
(12) Patent Application Publication
(10) Pub. No.: US 2018/0061275 A1
(43) Pub. Date: Mar. 1, 2018

(54) CHARACTER DISPLAY METHOD FOR BLIND PERSONS USING HAPTIC PATTERNS, AND TOUCH SCREEN AND DISPLAY DEVICE USING THE SAME

(71) Applicant: Dong Hyun PARK, Gangnam-gu, Seoul (KR)

(72) Inventor: Dong Hyun PARK, Gangnam-gu, Seoul (KR)

(21) Appl. No.: 15/551,417

(22) PCT Filed: Feb. 12, 2016
(86) PCT No.: PCT/KR2016/001429

§ 371 Date: Aug. 16, 2017

(30) Foreign Application Priority Data
Feb. 16, 2015 (KR) 10-2015-0023445

(51) Int. Cl. G09B 21/00; G06F 3/01; G06F 3/041

(52) U.S. Cl. CPC G09B 21/004; G06F 3/0414; G06F 3/016

(57) ABSTRACT

The present invention relates to a character display method for blind persons using haptic patterns, in which a plurality of character cells each having a pair of unit cells adjacent each other are configured on a touch screen which includes a touch panel for sensing a touch location of a user and an electro-sensitive panel integrated with the touch panel so as to transfer an electrical stimulus to a body part brought into contact with the touch screen, such that each of the unit cells provides a different haptic texture through a different electrical stimulus pattern, one character cell expresses various character symbols such as one Korean letter, English letter, an alphabet letter, a language character, number and special character through a combination of various haptic textures which are provided by the pair of unit cells, and the user can understand contents displayed on the touch screen through a combination of character symbols by recognizing haptic patterns transferred to a finger of the user while scanning the touch screen with the user's finger, and a touch screen and display device using the same.

### TECHNICAL FIELD

The present disclosure relates to a character display method for blind persons using haptic patterns, and a touch screen and display device using the same, and more particularly, to a character display method for blind persons using haptic patterns, in which a plurality of character cells each having a pair of unit cells adjacent each other are configured on a touch screen which includes a touch panel for sensing a touch location of a user and an electro-sensitive panel integrated with the touch panel so as to transfer an electrical stimulus to a body part brought into contact with the touch screen, such that each of the unit cells provides a different haptic texture through a different electrical stimulus pattern, one character cell expresses various character symbols such as one Korean letter, English letter, number and special character through a combination of various haptic textures which are provided by the pair of unit cells, and the user can understand contents displayed on the touch screen through a combination of character symbols by recognizing haptic patterns transferred to a finger of the user while scanning the touch screen with the user's finger, and a touch screen and display device using the same.

### BACKGROUND ART

Recently, the spread of various electronic and portable devices such as computers, mobile communication terminals, PDAs and PMPs has rapidly increased. The use of such electronic devices causes a different type of digital divide by deciding whether users can access digital information. Since the existing electronic devices are designed for non-disabled users, it is difficult for disabled users to access digital information through the electronic devices.

Therefore, various devices have been developed to enable the disabled users to use such electronic devices. The various devices may include a variety of output devices for providing information to a blind user through a sense of touch.

As an example of the output devices, a conventional braille display device includes a device that provides a driving force required for a vertical motion to raise or lower braille pins. Korean Patent Registration No. 1,181,811 discloses an actuator-based braille display that performs a vertical motion required for raising or lowering braille output pins, such that a blind user can read braille by sensing braille output pins raised on a braille cell through a touch of a finger.

However, the use of the actuator has made it difficult to miniaturize and integrate a solenoid as a braille output element, thereby making it difficult to reduce the size of the braille display device. Furthermore, the braille display device requires a high voltage to acquire a sufficient driving force. In addition, the braille display device not only has a low and irregular response speed, but also exhibits unsatisfactory durability.

In order to solve such problems, the present inventor has invented a technique registered as Korean Patent Registration No. 1,305,235. The technique discloses a braille input/output device that transmits an electrical stimulus to a body part of a user, brought into contact with a portion of a touch screen, such that the user can read a braille screen through the electrical stimulus transferred to the user's body part while scanning the touch screen with a finger.

In the above-described technique, however, the user must sequentially scan six sub areas arranged in each braille cell in a U-shaped manner, in order to recognize one braille character. Thus, the braille reading speed is slightly low. Furthermore, since a printing area divided into six areas is required to display one braille letter, the number of braille characters which can be provided on a limited screen area at the same time is considerably limited.

In addition, a variety of techniques have been developed, which enable blind users to easily acquire various pieces of information without using braille characters, based on the text-voice conversion technology. However, when the contents of a newspaper or book are delivered through voice, a user can simply receive the information through a sense of hearing, but does not feel that the user actively “reads” the information. Furthermore, the user may have difficulties in controlling the reading speed or range for himself.

### DISCLOSURE

### [Technical Problem]

Various embodiments are directed to a character display method for blind persons using haptic patterns, in which a plurality of character cells each having a pair of unit cells adjacent each other are configured on a touch screen which includes a touch panel for sensing a touch location of a user and an electro-sensitive panel integrated with the touch panel so as to transfer an electrical stimulus to a body part brought into contact with the touch screen, such that each of the unit cells provides a different haptic texture through a different electrical stimulus pattern, one character cell expresses various character symbols such as one Korean letter, English letter, number and special character through a combination of various haptic textures which are provided by the pair of unit cells, and the user can understand contents displayed on the touch screen through a combination of character symbols by recognizing haptic patterns transferred to a finger of the user while scanning the touch screen with the user's finger, and a touch screen and display device using the same.

### [Technical Solution]

In an embodiment, there is provided a character display method for blind persons, using a touch screen which includes a touch panel for sensing a touch location of a user and an electro-sensitive panel closely attached to the top of the touch panel so as to transfer an electrical stimulus to a body part brought into contact with the touch screen. A plurality of character cells each having a pair of unit cells adjacent to each other may be configured on the touch screen, such that each of the pair of unit cells provides an independent haptic texture through an independent electrical stimulus pattern, one character cell may express a character symbol including one Korean letter, English letter, number and/or special character through a combination of a pair of haptic textures which are independently provided by the pair of unit cells. While sequentially scanning the character cell with a body part of the user, a user may recognize a character expressed on the touch screen through a combination of haptic textures transferred to the user's body part for the respective unit cells.

### [Advantageous Effects]

According to the embodiment of the present invention, the plurality of character cells each having a pair of unit cells adjacent to each other may be configured on the touch screen, such that each of the unit cells provides a different haptic texture through a different electrical stimulus pattern, and one character cell may express various character symbols including one Korean letter, English letter, number and/or special character through a combination of various haptic textures which are provided by the unit cell. Various pieces of text information may be provided through a combination of character symbols, such that a user can recognize contents displayed on the touch screen by recognizing haptic patterns transferred to a finger of the user, while scanning the touch screen with the user's finger.

Furthermore, the character display method can enable a blind user to read contents which can be acquired on the web or written in the newspaper or book, through a sense of touch, using a terminal with a display such as a smart phone or note pad. Thus, the blind user can feel as if the blind user reads a general book. The character display method can display a screen composed of haptic patterns for a blind user and a character text for a general user at the same time, such that both the blind user and the general user can receive the text information through one terminal. Therefore, various service applications can be provided.

### BRIEF DESCRIPTION OF DRAWINGS

FIG. 1 illustrates a touch screen to which a character display method for blind persons using haptic patterns according to an embodiment of the present invention is applied.

FIG. 2 illustrates examples of haptic textures provided by a unit cell according to the embodiment of the present invention.

FIGS. 3 to 5 illustrate embodiments of the character display method for blind persons using haptic patterns.

FIG. 6 is a system diagram illustrating a display device using a touch screen according to an embodiment of the present invention.

### MODE FOR INVENTION

The present invention can be modified in various manners and have various forms. Therefore, specific embodiments will be described in detail with reference to the accompanying drawings.

However, the present invention is not limited to the specific embodiments, but may include all modifications, equivalents and substitutions within the scope of the present invention. The terms such as first and second may be used for describing various components, but the components are not limited by the terms. The terms are used only to distinguish one component from another component. For example, a first component may be referred to as a second component, and the second component may be referred to as the first component, without departing from the scope of the present invention.

The terms used in this specification are used only to describe specific embodiments, and do not limit the present invention. The terms of a singular form may include plural forms unless referred to the contrary. In this specification, the meaning of “include” or “have” specifies a property, number, step, process, element, part, or combinations thereof, but does not exclude one or more other properties, numbers, steps, processes, elements, parts, or combinations thereof.

Hereafter, preferred embodiments of the present invention will be described in detail with reference to the accompanying drawings.

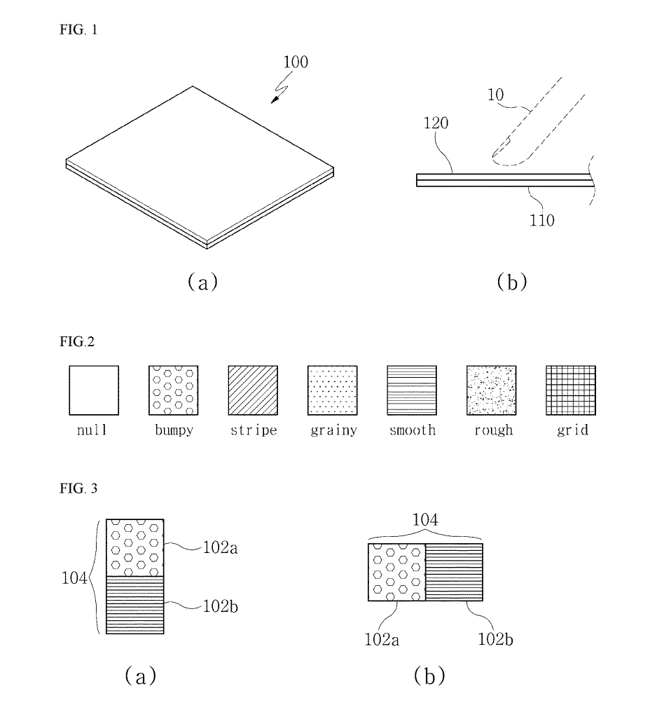

FIG. 1 illustrates a touch screen to which a character display method for blind persons using haptic patterns according to an embodiment of the present invention is applied, and FIG. 2 illustrates examples of a haptic texture provided by a unit cell according to the embodiment of the present invention.

As illustrated in FIG. 1, the touch screen 100 according to the embodiment of the present invention includes a touch panel 110 and an electro-sensitive panel 120. The touch panel 110 provides a screen and senses a touch location of a user, and the electro-sensitive panel 120 is installed over the touch panel 110 and generates an electrical signal.

The touch panel 110 to sense a touch location of a user may include various types of touch panels such as a capacitive touch panel, infrared touch panel, resistive touch panel and ultrasonic touch panel. When the touch panel 110 is touched by a body part such as a finger of the user, the touch panel 110 senses the touch to determine the touch location of the user.

The electro-sensitive panel 120 includes conductive electrodes with an insulator, and is installed on the touch panel 110. When the touch panel 110 senses a touch of the user's finger on the surface of the panel, the touch panel 110 transfers an electrical stimulus corresponding to the touch to the user's finger, depending on the location of the portion touched by the user's finger.

As disclosed in Korean Patent Publication No. 2010-0076968 applied for by SENSEG, the electro-sensitive panel 120 which has been recently developed and used generates an electrical signal depending on a contact location on the panel surface, and provides a predetermined electrical stimulus pattern to a body part of a user, brought into contact with the panel.

At this time, the generated electrical stimulus pattern can be modified in various manners by changing the characteristic factors of the electrical signal, such as a frequency, amplitude, waveform, duration and idle time of the electrical signal. The haptic feel which is felt through the user's finger according to the generated electrical stimulus pattern may be divided into various feels such as rough feel and smooth feel, thereby implementing various haptic patterns.

That is, when the touch screen is touched by a user's finger, cells present at the location touched by the user's finger generate an electrical signal and provide an electrical stimulus to the user's finger. At this time, the characteristic factors of the electrical signal, such as the frequency, amplitude, waveform, duration and idle time of the electrical signal, may be modified and combined to provide different haptic textures to the respective cells. As illustrated in FIG. 2, the haptic textures may include a bumpy texture, stripe texture, grainy texture, smooth texture, rough texture, grid texture and null texture. Thus, when the user scans the touch screen with his finger, the user can recognize a different haptic texture for each of the unit cells through a sense of touch.

As such, the present embodiment is configured in such a manner that the unit cells can provide different haptic textures through different electrical stimulus patterns. Specifically, a character cell including a pair of unit cells expresses one character, and various pieces of text information are provided through a combination of the characters. Hereafter, the character display method for blind users according to the present embodiment will be described with reference to a total of seven haptic textures illustrated in FIG. 2.

FIGS. 3 to 5 illustrate embodiments of the character display method for blind persons using haptic patterns.

Referring to FIGS. 3A and 3B, the character display method configures a plurality of character cells 104 each having a pair of unit cells 102 adjacent in the vertical or horizontal direction, such that each of the unit cells 102 can provide a different haptic texture through a different electrical stimulus pattern. Through various combinations of haptic textures provided from the pair of unit cells, one character cell 104 expresses various character symbols such as one Korean letter, English letter, number and special character.

For example, when a user scans the character cell 104 having the pair of unit cells 102 illustrated in FIG. 3 with the user's finger, an electrical stimulus corresponding to a haptic pattern allocated to the character cell 104 is transferred to the user's finger. Then, the user can recognize the character cell 104 displayed on the touch screen touched by the user and composed of ‘bumpy texture’ and ‘smooth texture’, for example. At this time, when it was promised that the character cell 104 in which ‘bumpy texture’ and ‘smooth texture’ are sequentially connected would indicate ‘ [symbol] (Korean letter)’, the user can read the Korean letter ‘ [symbol] ’ through the scanning process.

Since a character symbol such as one Korean letter, English letter, number or special character can expressed through one character cell composed of a pair of unit cells, combinations of the character symbols can generate various text combination systems on the haptic pattern screen.

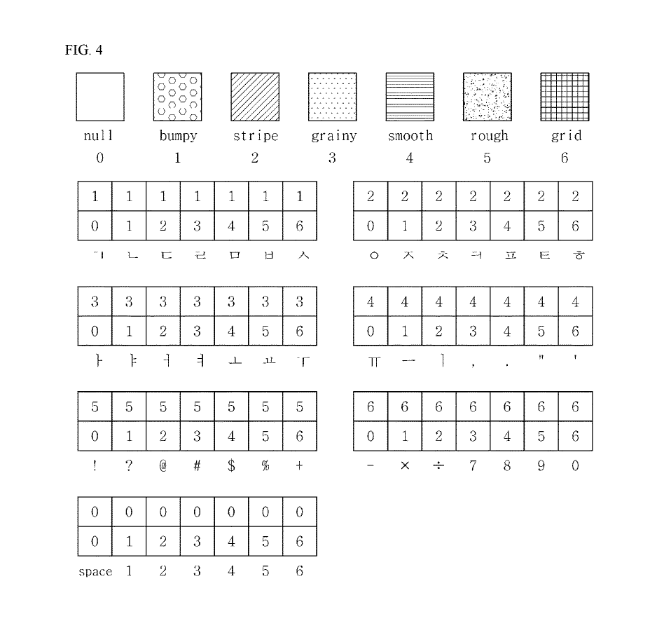

For example, when the null texture (no haptic feel) is represented by 0, the bumpy texture is represented by 1, the stripe texture is represented by 2, the grainy texture is represented by 3, the smooth texture is represented by 4, the rough texture is represented by 5, and the grid texture is represented by 6 as illustrated in FIG. 2, each of the unit cells can express seven different senses. Thus, a total of 49 (=7*7) character cells can combined through a pair of unit cells. FIG. 4 illustrates an example of a text combination system on a haptic pattern screen in which the 49 pairs of unit cell combinations are used to express Korean letters and numbers.

When it is assumed that a text ‘ [symbol] (our country in English)’ was displayed on the touch screen as illustrated in FIG. 5 based on the text combination system of FIG. 4, the user sequentially scans the corresponding character cells with a finger along the arrow direction. At this time, each of the unit cells transfers an electrical stimulus to the user's finger, the electrical stimulus corresponding to a haptic texture allocated to the unit cell. Thus, the user can feel ‘stripe texture’ and ‘null texture’ at the upper unit and lower unit cells of the first character cell, respectively, and then recognize a Korean letter ‘ [symbol] ’. Then, the user can sequentially can the following character cells, and thus read the text ‘ [symbol] ’ displayed on the touch screen through electrical stimuli transferred to the finger for the respective character cells.

At this time, in order to support the user to more accurately recognize the haptic pattern, the respective character cells may be arranged with a predetermined distance d therebetween, or divided by a scratch-type electrical stimulus pattern 300 provided on the touch screen. Furthermore, when character symbols such as Korean characters in which several letters are combined to form one character are displayed, the distance d between the character cells may be adjusted, and/or an electrical stimulus pattern 301 having a different shape from the electrical stimulus pattern for dividing character cells may be used, in order to distinguish between the characters.

In the present embodiment illustrated in FIG. 4, each of a pair of adjacent unit cells can express seven different textures through seven haptic textures, thereby expressing Korean letters and numbers through a total of 49 combinations. However, the present embodiment is not limited thereto, but more various haptic patterns can be used to combine more texts such as English letters or special characters.

FIG. 4 is only an example of the character display method for blind user based on haptic patterns according to the embodiment of the present invention. In other words, the present invention is not limited thereto, but various haptic pattern systems can be provided as long as mutual promises can be made between a haptic pattern electronic file provider and users.

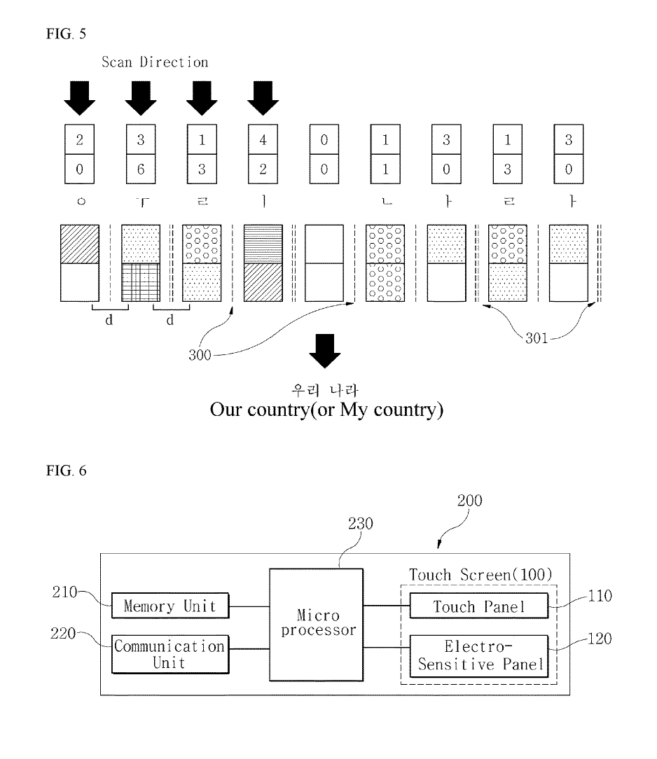

FIG. 6 is a system diagram illustrating a display device using a touch screen according to an embodiment of the present invention.

The display device using a touch screen according to the embodiment of the present invention can be applied to any terminals including mobile terminals such as typical smart phones, as long as the terminals have a memory embedded therein or can execute a haptic pattern program (software) through a network communication. The haptic pattern program will be described below.

As illustrated in FIG. 6, the display device 200 using a touch screen according to the embodiment of the present invention includes a touch screen 100, a memory unit 210, a communication unit 220 and a microprocessor 230.

The touch screen 100 includes the touch panel 110 and the electro-sensitive panel 120 as described with reference to FIG. 1. The touch screen 100 provides an image screen including a haptic pattern screen through the touch panel 110, senses a touch location of a user on the touch screen 100, and transfers an electrical stimulus to a body part (finger) of the user through the electro-sensitive panel 120 according to the user's touch location.

The touch screen 100 may include a plurality of character cells each having a pair of unit cells adjacent to each other, such that each of the unit cells provides a different haptic texture through a different electrical stimulus pattern. Thus, one character cell can express various character symbols such as one Korean letter, English letter, number and special character through various combinations of haptic textures provided by the pair of unit cells, and the combinations of the character symbols can provide various pieces of text information. Then, while scanning the touch screen with a finger, the user can recognize a haptic pattern transferred to the user's finger and thus understand the contents displayed on the touch screen.

At this time, a character text is simultaneously displayed on the touch screen 100 such that a general user as well as the blind user can recognize the contents. When a touch location of a body part of the user is sensed through the touch panel 110 of the touch screen 100, the touch screen 100 may generate an electrical stimulus of a haptic pattern corresponding to the touch location, such that both of the blind user and the general user can use the corresponding terminal.

The memory unit 210 may store text combination system recognization information on the haptic pattern screen provided through the touch screen 100 and an electrical signal generation program (software) that generates an electrical signal for providing an electrical stimulus of a haptic texture corresponding to each of the unit cells according to the text combination system recognization method. In addition, the memory unit 210 may store terminal information or terminal user information and/or various electronic files including electronic files converted into haptic patterns.

The communication unit 220 includes a wired/wireless communication module to receive various contents including electronic files converted into haptic patterns which can be connected through a communication network such as the Internet or the like.

The microprocessor 230 controls the operations of the respective units, and provides an electronic file converted into haptic patterns to a user such that the user can read the electronic file. That is, the microprocessor 230 converts an electronic file stored in the memory unit 210 or an electronic file received through the communication unit 220 according to the haptic pattern system information stored in the memory unit 210, provides the converted electronic file to the user through the touch screen, senses a touch location through the touch panel 110 of the touch screen, generates an electrical signal corresponding to the touch location, and provides an electrical stimulus of the corresponding pattern to a body part (finger) of the user, brought into contact with the touch screen, through the electro-sensitive panel 120.

As described above, the display device according to the present embodiment can receive an electronic file composed of a text, convert the electronic file into an electronic file composed of haptic patterns through the microprocessor 230, and provide the converted electronic file through the touch screen. Furthermore, when a previously stored electronic file composed of a haptic pattern is present or an electronic file composed of a haptic pattern has been already received through a network, the display device can display a screen according to the haptic pattern contained in the electronic file, and provide an electrical stimulus of the corresponding haptic texture.

Furthermore, the display device according to the present embodiment may additionally include various input/output devices, such as an input button and speaker, other than the above-described units.

As described above, the character display method and the display device using the same according to the present embodiments may configure a plurality of character cells each having a pair of unit cells adjacent to each other on the touch screen, such that each of the unit cells provides a different haptic texture through a different electrical stimulus pattern. Thus, one character cell can express various character symbols such as one Korean letter, English letter, number and special character through various combinations of haptic textures provided from each of the unit cells, and the combinations of the character symbols can provide various pieces of text information. Then, while scanning the touch screen with a finger, a user can recognize a haptic pattern transferred to the user's finger and thus understand contents displayed on the touch screen. Furthermore, the character display method and the display device using the same can enable a blind user to read contents which can be acquired on the web or written in the newspaper or book, through a sense of touch, using a terminal with a display such as a smart phone or note pad. Thus, the blind user can feel as if the blind user reads a general book.

While various embodiments have been described above, it will be understood to those skilled in the art that the embodiments described are by way of example only. Accordingly, the disclosure described herein should not be limited based on the described embodiments.

### INDUSTRIAL APPLICABILITY

The character display method and the display device using the same can enable a blind user to read contents which can be acquired on the web or written in a newspaper or book, through a sense of touch, using a terminal with a display such as a smart phone or note pad. Thus, the blind user can feel as if the blind user read a general book. Furthermore, the character display method and the display device using the same can display a screen composed of haptic patterns for the blind user and a character text for a general user at the same time, such that both the blind user and the general user can receive the text information through one terminal. Therefore, various service applications can be provided.

1. A character display method for a blind user, using a touch screen which includes a touch panel for sensing a touch location of a user and an electro-sensitive panel overlying the touch panel so as to transfer an electrical stimulus to a body part brought into contact with the touch screen,
wherein a plurality of character cells each having a pair of unit cells adjacent to each other are configured on the touch screen, such that each of the pair of unit cells provides an independent haptic texture through an independent electrical stimulus pattern, and one character cell expresses a character symbol including one Korean letter, English letter, an alphabet letter, a language character, number and/or special character through a combination of a pair of haptic textures which are independently provided by the pair of unit cells,
wherein while sequentially scanning the character cell with a body part of the user, the user recognizes a character expressed on the touch screen through a combination of haptic textures transferred to the user's body part for the respective unit cells.

2. The character display method of claim 1, wherein the haptic pattern is implemented through a modification and combination of characteristic factors of an electrical signal applied to the electro-sensitive panel, the characteristic factors including a frequency, amplitude, waveform, duration and idle time of the electrical signal.

3. The character display method of claim 1, wherein the pair of cells in the character cell are arranged relative to each other in a vertical or horizontal direction.

4. The character display method of claim 1, wherein the haptic texture comprises seven different textures.

5. A touch screen for blind persons using haptic patterns, comprising a touch panel for sensing a touch location of a user and an electro-sensitive panel closely overlying the touch panel so as to transfer an electrical stimulus to a body part brought into contact with the touch screen,
wherein the touch screen configures a plurality of character cells each having a pair of unit cells adjacent to each other on the touch screen, such that each of the pair of unit cells provides an independent haptic texture through an independent electrical stimulus, and one character cell expresses a character symbol including one Korean letter, English letter, an alphabet letter, a language character, number and/or special character through a combination of a pair of haptic textures which are independently provided by the pair of unit cells,
wherein the touch screen transfers an electrical stimulus pattern corresponding to the user's touch location through the electro-sensitive panel according to the user's touch location sensed through the touch panel, such that while sequentially scanning the character cell with a body part of the user, the user recognizes a character expressed on the touch screen through a combination of haptic textures transferred to the user's body part for the respective unit cells.

6. The touch screen of claim 5, wherein the haptic pattern is implemented through a modification and combination of characteristic factors of an electrical signal applied to the electro-sensitive panel, the characteristic factors including a frequency, amplitude, waveform, duration and idle time of the electrical signal.

7. The touch screen of claim 5, wherein the pair of cells in the character cell are arranged relative to each other in a vertical or horizontal direction.

8. The touch screen of claim 5, wherein the character cells are separated at preset intervals from each other, in order to distinguish the character cells from each other.

9. The touch screen of claim 5, wherein the touch screen provides a scratch-type electrical stimulus pattern between the respective character cells provided on the touch screen, in order to distinguish the character cells from each other.

10. A display device for blind persons using haptic patterns, comprising the touch screen of claim 5 and a microprocessor for controlling an operation of the touch screen,
wherein the display device provides a text screen composed of haptic patterns on the touch screen through the microprocessor, and transfers an electrical stimulus pattern corresponding to a touch location of a user to a body part of the user, brought into contact with the touch screen, according to the user's touch location sensed on the touch screen,
wherein while sequentially scanning a character cell displayed on the touch screen using the user's body part, the user recognizes a character expressed on the touch screen through a specific combination of haptic textures transferred to the user's body part for the respective unit cells.

11. The display device of claim 10, wherein the display device provides a text screen composed of visual characters for a general user and the text screen composed of the haptic patterns on the touch screen at the same time.

12. The character display and method of claim 4, wherein the different textures comprise a null texture indicating no haptic feel, a bumpy texture, a stripe texture, a grainy texture, a smooth texture, a rough texture and a grid texture.
